(19) United States
(12) Patent Application Publication
(10) Pub. No.: US 2024/0424652 A1
(43) Pub. Date: Dec. 26, 2024

(54) ATTACHMENT MECHANISM FOR A POWER TOOL

(71) Applicant: MILWAUKEE ELECTRIC TOOL CORPORATION, Brookfield, WI (US)

(72) Inventors: Devin C. Albrecht, Hartford, WI (US); Jay M. Klubertanz, Hartford, WI (US)

(21) Appl. No.: 18/709,748

(22) PCT Filed: Nov. 16, 2022
(86) PCT No.: PCT/US2022/050123

§ 371 Date: May 13, 2024

Related U.S. Application Data
(60) Provisional application No. 63/280,243, filed on Nov. 17, 2021.

(51) Int. Cl. B25F 3/00; B23B 45/02; B25D 17/08; B25F 5/00

(52) U.S. Cl. CPC B25F 3/00; B23B 45/02; B25F 5/001; B25D 17/08; B25D 2250/121

(57) ABSTRACT

A power tool system including a power tool base having a main body, an electric including an output, and a tool-side attachment mechanism coupled to the main body, the tool-side attachment mechanism having a tool-side locking lug and a tool-side slot adjacent the tool side locking lug. An accessory is configured to be selectively coupled to the power tool base and includes an accessory-side attachment mechanism having an accessory-side locking lug and an accessory-side slot, the accessory-side locking lug selectively engagable with the tool side slot and the accessory-side slot selectively engagable with the tool-side locking lug, a gear arrangement configured to be operably coupled to the output of the electric motor to receive torque from the electric motor, and a tool holder configured to be driven by the gear arrangement. The accessory-side attachment mechanism selectively engages the tool-side attachment mechanism to axially couple the accessory to the power tool base.

### CROSS-REFERENCE TO RELATED APPLICATIONS

This application claims the benefit of co-pending U.S. Provisional Patent Application No. 63/280,243, filed on Nov. 17, 2021, the entire contents of which are incorporated by reference herein.

### FIELD OF THE INVENTION

The present invention relates to power tools, and more particularly to rotary power tools, such as drill drivers and the like.

### BACKGROUND OF THE INVENTION

Power tools, particularly rotary power tools, are often user-configurable to provide compatibility with different types and sizes of tool accessories. This may include different types of bits or different tool holders (e.g. three jaw chuck, collet). However, the same drive system is generally used to drive these accessories. This does not always allow for the most customized approach to each accessory. For example, some accessories may operate more effectively at certain torque ranges, certain speed ranges, certain gear ratios, etc. Additionally, the mechanism used to couple the tool holder to the tool may be improved for ease of use. The present disclosure seeks to further customize the power tool for different accessories with a simplistic user-friendly attachment mechanism.

### SUMMARY OF THE INVENTION

The present disclosure provides, in one aspect, a power tool system including a power tool base having a main body, an electric motor disposed within the main body, the electric motor including an output, and a tool-side attachment mechanism coupled to the main body, the tool-side attachment mechanism having a tool-side locking lug and a tool-side slot adjacent the tool-side locking lug. An accessory is configured to be selectively coupled to the power tool base and includes an accessory-side attachment mechanism having an accessory-side locking lug and an accessory-side slot, the accessory-side locking lug selectively engagable with the tool-side slot and the accessory-side slot selectively engagable with the tool-side locking lug, a gear arrangement configured to be operably coupled to the output of the electric motor to receive torque from the electric motor, and a tool holder configured to be driven by the gear arrangement. The accessory-side attachment mechanism selectively engages the tool-side attachment mechanism to axially couple the accessory to the power tool base.

The present disclosure provides, in another aspect, an attachment mechanism for connecting an accessory to a rotary power tool, where the attachment mechanism includes a tool-side attachment having a plurality of tool-side locking lugs extending from the tool-side attachment, and a plurality of tool-side locking slots. The attachment mechanism further includes an accessory-side attachment having a plurality of accessory-side locking lugs extending from the accessory-side attachment, the plurality of accessory-side locking lugs engagable with the plurality of tool-side locking slots, a plurality of accessory-side locking slots engagable with the plurality of tool-side locking lugs, and an actuator extending from one of the accessory-side attachment or the tool-side attachment, the actuator operable to rotate the accessory-side attachment and tool-side side attachment relative to one another between a locked and an unlocked position.

The present disclosure provides, in yet another aspect, an accessory for use with a rotary power tool having a tool-side attachment mechanism and an electric motor, where the accessory includes a housing having a front end and a rear end opposite the front end, the rear end configured to be selectively coupled to the rotary power tool, an accessory-side attachment mechanism configured to selectively couple the accessory to the rotary power tool, the accessory-side attachment mechanism capable of limited rotation with respect to the housing, a gear arrangement supported by the housing, the gear arrangement configured to receive torque from the electric motor when the accessory is coupled to the rotary power tool, and a tool holder disposed within the housing closer to the front end than the gear arrangement and operably coupled to the gear arrangement.

Other features and aspects of the invention will become apparent by consideration of the following detailed description and accompanying drawings.

### BRIEF DESCRIPTION OF THE DRAWINGS

FIG. 1 is perspective view of a power tool in accordance with one embodiment of the present disclosure.

FIG. 2 is a perspective view of a portion of the base of FIG. 1, illustrating a tool-side attachment according to one embodiment.

FIG. 3 is a perspective view of the accessory of the power tool of FIG. 1 illustrating an accessory-side attachment according to one embodiment.

FIG. 4 is a cross-sectional view of a portion of the power tool of FIG. 1 taken along line 4-4 shown in FIG. 1.

FIG. 5 is a front perspective view of the tool-side of the attachment mechanism illustrated in FIG. 2.

FIG. 6 is a rear perspective view of the tool-side of the attachment mechanism illustrated in FIG. 2.

FIG. 7 is a side plan view of the tool-side attachment mechanism illustrated in FIG. 2.

FIG. 8 is a front perspective view of the accessory-side attachment mechanism illustrated in FIG. 3.

FIG. 9 is a rear perspective view of the accessory-side attachment mechanism illustrated in FIG. 3.

FIG. 10 is a top view of a power tool in accordance with another embodiment of the present disclosure.

FIG. 11 is a perspective view of the base of FIG. 10.

FIG. 12 is a perspective view of a portion of the base of FIG. 11, illustrating a tool-side attachment according to one embodiment.

FIG. 13 is a rear perspective view of the accessory of the power tool of FIG. 10 illustrating an accessory-side attachment according to one embodiment

FIG. 14 is a front perspective view of the accessory of the power tool of FIG. 10 illustrating an accessory-side attachment according to one embodiment FIG. 15 is a perspective view of the attachment mechanism of FIGS. 12 and 13.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

Power tools, particularly rotary power tools, are often user-configurable to provide compatibility with different types and sizes of tool accessories. This may include different types of bits or different tool holders (e.g. three jaw chuck, collet). However, customization for the type of tool accessory is limited. For example, the same drive system is generally used to drive these accessories. This does not always allow for the most customized approach to each accessory. Some accessories may operate more effectively at certain torque ranges, certain speed ranges, certain gear ratios, etc. The present disclosure seeks to further customize the power tool for different accessories, and furthermore, for accessories having different gear arrangements and/or different torque needs. For example, by moving the gear arrangement from the power tool into the accessory, each accessory may be equipped with a customized gear arrangement that compliments the needs of that particular tool. Additionally, the mechanism used to couple the accessory to the tool may be improved for ease of use by implementing a simplistic user-friendly attachment mechanism.

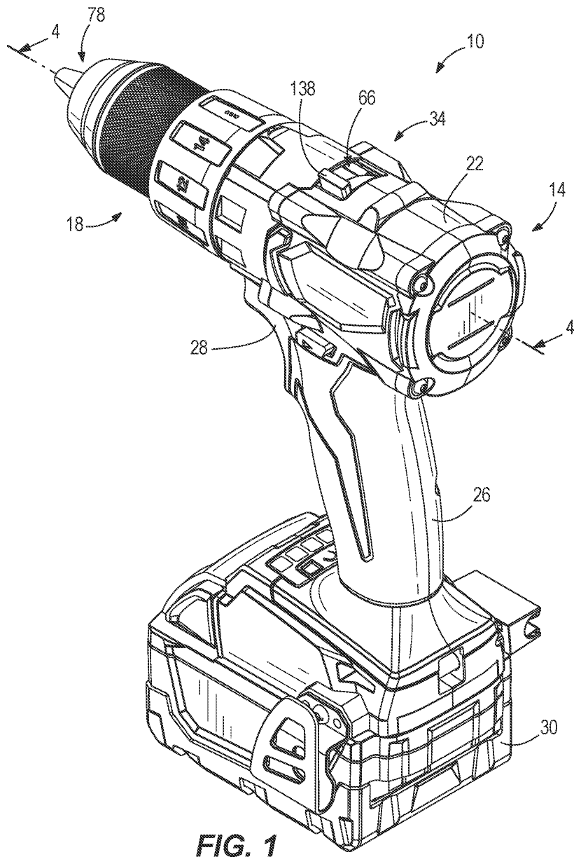

FIG. 1 illustrates a rotary power tool 10 including a base 14 and an accessory 18 selectively coupled to the base 14. The base 14 includes a main body 22, a handle 26 extending from the main body 22, and a battery 30 removably coupled to the handle 26. A front end 34 of the main body 22 is configured to receive a plurality of different accessories 18 to be used with the power tool 10. For example, in one embodiment, the front end 34 of the base 14 may be configured to receive a drill driver accessory 18 as shown in FIG. 1. The front end 34 may also receive other accessories not shown herein, such as adapters for use with ¼″, ⅜″, and 7/16″ hex sockets. Each accessory may include customized features for that particular type of accessory. For example, the accessory may include a gear train optimized to have a specific output torque for driving a specific type of fastener, or it may include a hammer mechanism such that the rotary power tool 10 operates as a hammer drill. As will be described in greater detail, the base 14 is configured to be selectively coupled to a plurality of different accessories 18 via an attachment mechanism 38. A portion of the attachment mechanism 38 is integrated into the front end 34 of the base 14 (i.e., a tool-side attachment mechanism 90) and a portion of the attachment mechanism 38 is integrated into a rear end 36 of the accessory 18 (i.e., an accessory-side attachment mechanism 94). As will be understood by a person skilled in the art, in some embodiments, the portions of the attachment mechanism 38 described herein as being integrated into the base 14 may be alternatively integrated into the accessory 18, and vice versa.

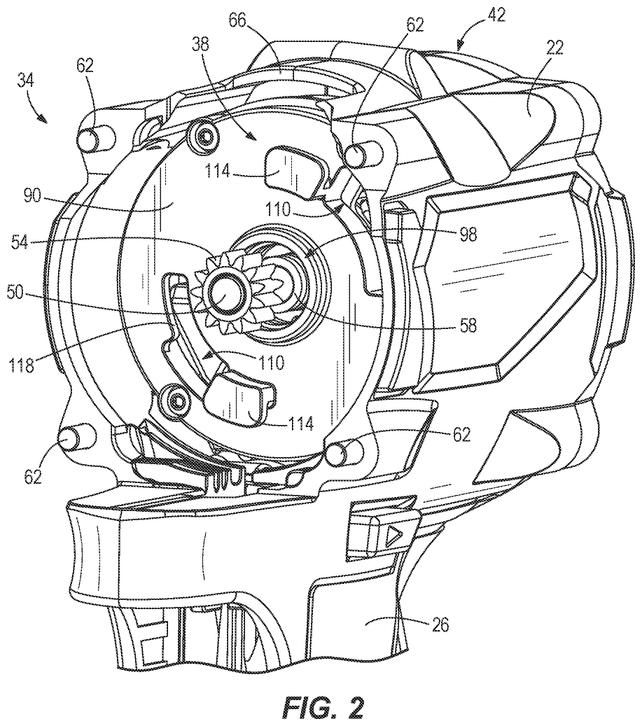

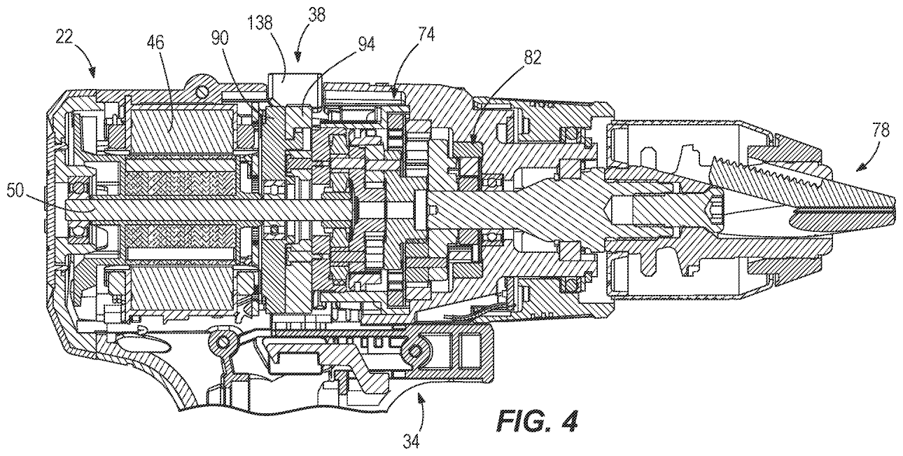

FIG. 2 provides a detailed view of the base 14 with the accessory 18 removed. An electric motor 46, illustrated as an internal rotor electric motor, is disposed within a rear portion 42 of the main body 22 behind the tool-side attachment mechanism 90 (shown in FIG. 4). In some embodiments, the electric motor 46 may be another type of motor, such as an external rotor electric motor. The electric motor 46 is selectively electrically coupled to the battery 30 via a trigger switch 28 on the handle 26. The front end 34 extends from the main body 22 beyond the electric motor 46 such that the accessory 18 is received forward of the electric motor 46. An output of the electric motor 46 is mechanically coupled to an input of the accessory 18 when the accessory 18 is installed on the base 14. In other words, the input refers to the portion of the accessory 18 that is driven by the output of the electric motor 46. In the illustrated embodiment, the output of the electric motor 46 is depicted as an output shaft 50 having a drive gear 54 mounted on an end thereof. The output shaft 50 is supported by a bearing 58 and is configured to extend into the attachment mechanism 38 to drivingly engage the accessory 18. The output shaft 50 may be arranged in different configurations to drivingly engage the accessory 18. For example, in the illustrated embodiment, the output shaft 50 extends though both the tool-side attachment mechanism 90 and the accessory-side attachment mechanism 94 to engage the input of the accessory 18. However, in other embodiments, the output shaft 50 only extends through the tool-side attachment mechanism 90. Furthermore, in some embodiments, the input of the accessory 18 may be an input shaft that extends through the attachment mechanism 38 and be received by the output shaft 50 of the base 14. Likewise, the input of the accessory 18 may extend through one or both the tool-side attachment mechanism 90) and the accessory-side attachment mechanism 94.

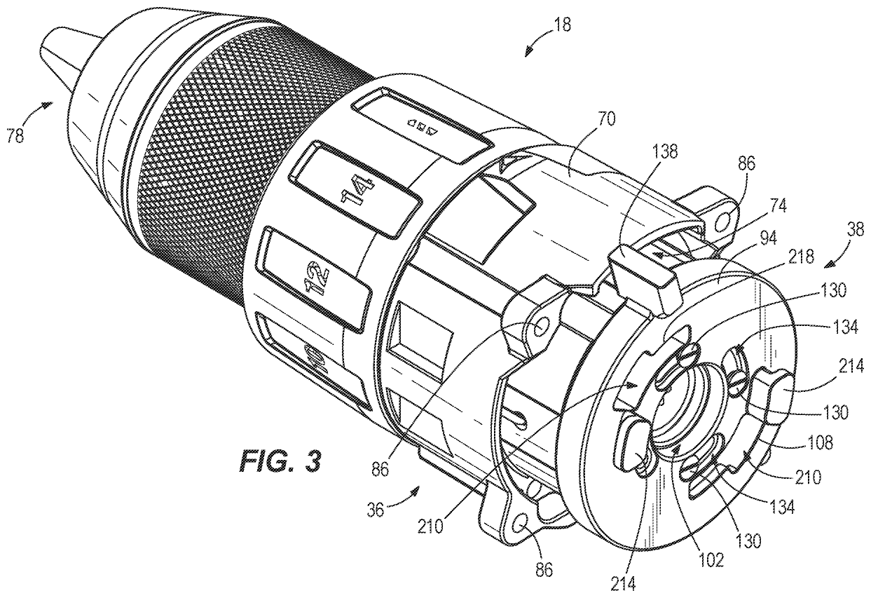

Referring now to FIGS. 3 and 4, the accessory 18 is shown separated from the base 14. The accessory 18 includes a housing 70, a gear box 74 (i.e., the input), a tool holder 78, and a portion of the attachment mechanism 38 (i.e., the accessory-side attachment mechanism 94).

The gear box 74 (shown in FIG. 4) is disposed within the housing 70 and is selectively driven by the output of the base 14 when the accessory 18 is coupled to the base 14. In this way, the gear box 74 functions as the input of the accessory 18. In the illustrated embodiment, the gear box 74 is engageable with the drive gear 54 of the output shaft 50 of the electric motor 46 to receive torque therefrom. The gear box 74 is a gear system including any number of gears or gear arrangements. In some embodiments, the accessory 18 may be a direct drive style of tool in which the accessory 18 is directly driven by the output shaft 50 of the base 14 without any gears disposed therebetween. In this case, the gear box would primarily include a coupling mechanism connecting the output of the base 14 with the tool holder 78. For example, the gear box may be in the form of an input shaft that is coupled to and driven by the output shaft 50 without a step up or down in gear ratio.

In some embodiments, the base 14 may be compatible with a variety of different types of accessories, where each accessory 18 includes gear box 74 having a different gear arrangement. As previously discussed, some accessories 18 may operate more effectively at certain torque ranges, certain speed ranges, certain gear ratios, etc. For example, the base 14 may be operable to drive a drill, a reciprocating tool, a cutting tool, a rotary hammer, a hammer drill, or other types of accessories, which each operate best at different torque ranges, speed ranges, or gear ratios. By including the gear arrangement within the accessory 18, as opposed to the base 14, each accessory 18 may be equipped with a customized gear arrangement that compliments the needs of that particular tool. In other words, each of these accessories 18 may include a gear box 74 having a different gear arrangement customized for the torque and/or speed needs of that particular tool. For example, the base 14 may be coupled to a first accessory 18a having a first gear box 74a with a first gear arrangement, which provides a desired torque and speed designed for the first accessory 18a. The base 14 may also be coupled to a second accessory 18b having a second gear box 74b with a second gear arrangement, which provides a desired torque and speed designed for the second accessory 18b.

With continued reference to FIGS. 3 and 4, the tool holder 78 is illustrated as a three-jaw chuck: however, a person skilled in the art will understand the interchangeability of the three-jaw chuck with other tool holders (e.g., a collet). Furthermore, in other embodiments or on other accessories 18 the tool holder 78 may be other types of working implements, such as a reciprocating tool, a cutting tool, a hammer drill tool, or a rotary drill tool. The tool holder 78 is operably coupled to the gear box 74 at an axially forward end thereof and is configured to support a working tool (not shown) such as a drill bit. The attachment mechanism 38 is disposed within the axially rear end 36 of the accessory 18 (e.g., opposite the tool holder 78).

In some embodiments, the accessory 18 includes a clutch mechanism 82 disposed between the gear box 74 and the tool holder 78 (See FIG. 4). The clutch mechanism 82 limits the torque transferred between the gear box 74 and the tool holder 78 and may be mechanical or electrical in nature. Due to the gear box 74 being integrated into the accessory 18, each accessory 18 can be configured with a gear train having a torque output optimized for the accessory's intended use. The gear box 74 of the illustrated drill driver accessory 18 is a planetary gear box which receives the drive gear 54 as its sun gear. In this way, the electric motor 46 is coupled to the accessory 18 to transmit torque to the working tool.

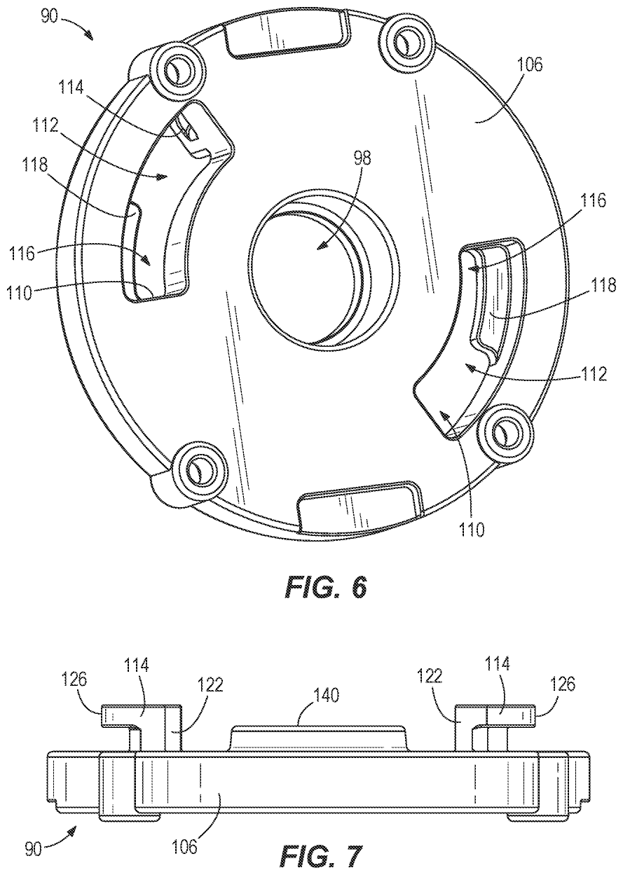

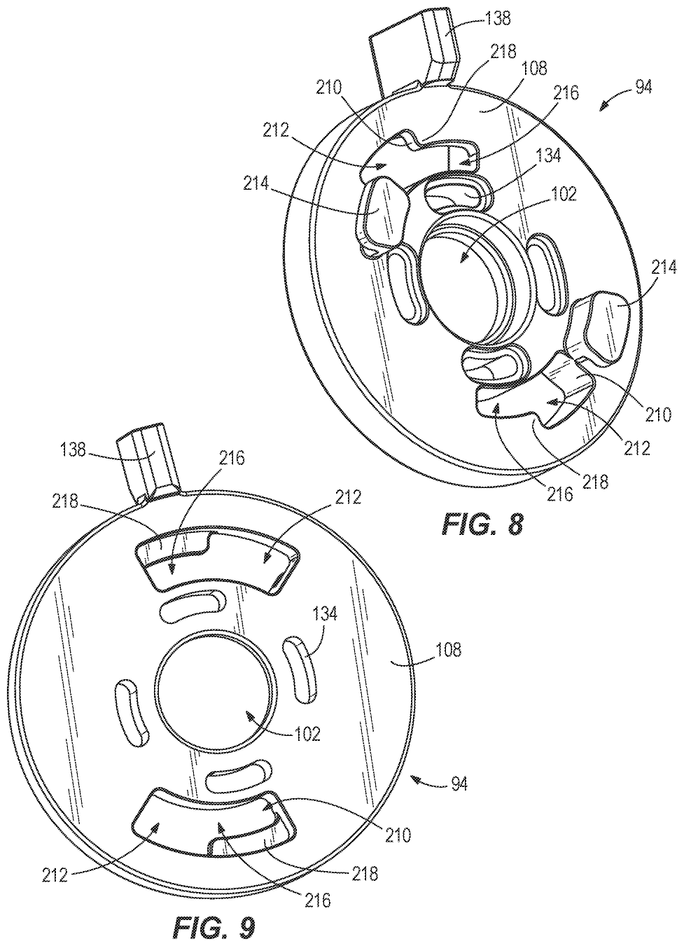

FIGS. 2-9 illustrate one embodiment of an attachment mechanism 38 for selectively securing the accessory 18 to the base 14. The attachment mechanism 38 includes the tool-side attachment mechanism 90 and the accessory-side attachment mechanism 94. In the illustrated embodiment, the tool-side attachment mechanism 90 is positioned within the front end 34 of the main body 22 and includes a central aperture 98 through which the output shaft 50 and drive gear 54 extend. The accessory-side attachment mechanism 94 is positioned within the rear end 36 of the accessory 18 and includes a central aperture 102 configured to receive the output shaft 50 and drive gear 54 of the base 14 when the accessory 18 is attached to the base 14. Together, the tool-side attachment mechanism 90 and accessory-side attachment mechanism 94 axially secure the accessory 18 to the base 14.

With reference to FIGS. 2 and 4-7, the tool-side attachment mechanism 90 is positioned forwardly of the electric motor 46 (e.g., adjacent the output shaft 50) and is mounted in an axially and rotationally fixed manner. The tool-side attachment mechanism 90 includes a body 106 formed as a plate, however, in other embodiments, the tool-side attachment mechanism 90 may have other shapes. A plurality of locking slots 110 and a plurality of locking lugs 114 are disposed circumferentially around the central aperture 98. Although the illustrated embodiment includes two slots 110 and two locking lugs 114, a greater or smaller number of slots 110 and locking lugs 114 may be used.

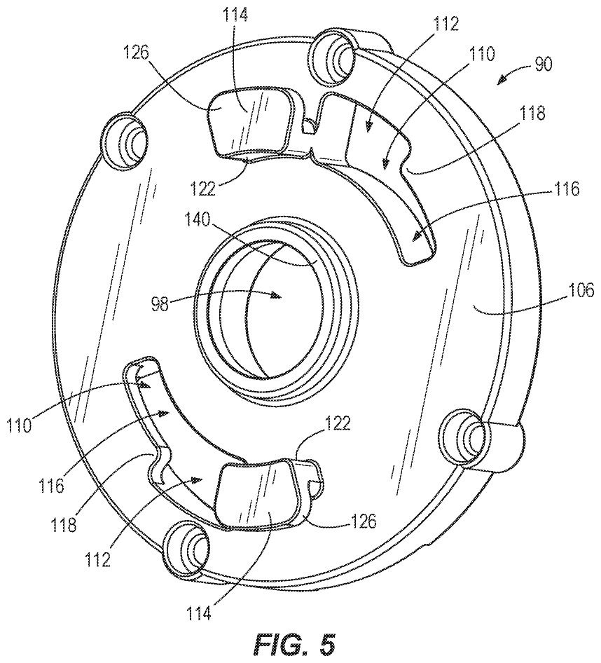

As best shown in FIG. 5, each slot 110 includes a receiving portion 112 and a locking portion 116. In the illustrated embodiment, the slot 110 is of a constant width and forms an arc shape around a portion of the central aperture 98. A portion of each slot 110 includes a locking shelf 118 extending radially across a portion of the slot 110 to form the locking portion 116. The locking shelf 118 does not extend across the entire width of the slot 110. Rather, the locking shelf 118 effectively narrows the width of the slot 110 to form the locking portion 116. The portion of the slot 110 not partially covered by the locking shelf 118 forms the receiving portion 112. However, in other embodiments, the slots 110 may have alternative shapes to create a receiving portion 112 and a locking portion 116. For example, in some embodiments, each slot 110 may include a wide portion (i.e., the receiving portion 112) and a thin portion (i.e., the locking portion 116), where the thin portion has a decreased width relative to the wide portion. In this embodiment, the thin portion may be used to replace the locking shelf 118. The locking lugs 114 of the illustrated embodiment are substantially L-shaped. In other embodiments, the locking lugs 114 may be substantially T-shaped.

Additionally, in some embodiments, the tool-side attachment mechanism 90 includes a ring 140 extending around the central aperture 98. The ring 140 extends axially in order to protrude from the surface of the body 106 in the same direction as the locking lugs 114. When the accessory 18 is attached to the base 14, the ring 140 is received within the central aperture 102 of the accessory-side attachment mechanism 94. As will be understood, in some embodiments, the ring 140 may be positioned on the accessory-side attachment mechanism 94 or may be omitted entirely. The ring 140 may help to enable alignment and rotation between the tool-side attachment mechanism 90 and the accessory-side attachment mechanism 94.

With reference to FIGS. 2, 4, and 8-9, the accessory-side attachment mechanism 94 is mounted to the accessory 18 in an axially fixed manner. However, unlike the tool-side attachment mechanism 90, at least a portion of the accessory-side attachment mechanism 94 is capable of limited rotation. The accessory-side attachment mechanism 94 includes a body 108 formed as a plate, however, in other embodiments, the accessory-side attachment mechanism 94 may have other shapes. In order to allow limited rotation, the accessory-side attachment mechanism 94 is secured to the rear end 36 of the accessory 18 via a plurality of securement pins 130. The illustrated embodiment includes four pins 130 located circumferentially around the central aperture 102, however, greater or fewer pins 103 may be used. Each securement pin 130 is disposed within an elongated aperture 134 that allows for movement of the securement pin 130 within the elongated aperture 134. In that respect, the accessory-side attachment mechanism 94 is axially fixed but is capable of rotating a distance corresponding to the arc length of the elongated aperture 134. In particular, the body 108 of the accessory-side attachment mechanism 94 may rotate between a locked position and an unlocked position.

The accessory-side attachment mechanism 94 further includes a plurality of locking lugs 214 and slots 210 corresponding in number to the locking lugs 114 and slots 110 of the tool-side attachment mechanism 90. The locking lugs 214 and slots 210 have a the same or a similar shape as the locking lugs 114 and slots 110 as the tool-side attachment, so they will only be briefly described. The locking lugs 214 and slots 210 are arranged circumferentially around the central aperture 102. The slots 210 each include a receiving portion 212 and a locking portion 216. In the illustrated embodiment, the slot 210 is of a constant width and forms an arc shape around a portion of the central aperture 102. A portion of each slot 210 includes a locking shelf 218 extending radially over a portion of the slot 210 to form the locking portion 216. The portion of the slot 210 not covered by the locking shelf 218 forms the receiving portion 212. As explained above, the slots 210 may have alternative shapes to create a receiving portion 212 and a locking portion 216. The locking lugs 214 of the illustrated embodiment are substantially L-shaped.

The locking lugs 214 and slots 210 of the accessory-side attachment mechanism 94 are arranged such that, when the accessory 18 is installed on the base 14, the accessory-side locking lugs 214 align with the tool-side slots 110 and the tool-side locking lugs 114 align with the accessory-side slots 210. More specifically, the locking lugs 214 of the accessory-side attachment mechanism 94 align with the receiving portion 112 portion of the slot 110 in the tool-side attachment mechanism 90. Likewise, the locking lugs 114 of the tool-side attachment mechanism 90 align with the receiving portion 212 of the slot 210 in the accessory-side attachment mechanism 94. The slots 110, 210 are sized such that corresponding locking lug 114, 214 can pass through the receiving portion 112, 212. Once the body 108 of the accessory-side attachment mechanism 94 is rotated relative to the tool-side attachment mechanism 90, towards the locked position, the locking lugs 114, 214 are move from the receiving portion 112, 212 towards the locking portion 116, 216, respectively. The locking shelf 118, 218 effectively narrows the receiving portion 112, 212 of the slot 110, 210 thereby creating a surface for the corresponding locking lug 114, 214 to abut. This prevents axial movement of the locking lugs 114, 214 and, thereby, prevents axial movement of the accessory 18 relative to the base 14 of the power tool 10.

More specifically, as mentioned, the locking lugs 114 are L-shaped so that each locking lug 114 includes an axially extending portion 122 and a radially extending portion 126. The axially extending portion 122 is sized such that, when inserted into a corresponding slot 210 of the accessory-side attachment mechanism 94, the radially extending portion 126 is located on the opposite side of the accessory-side attachment's body 106. The radially extending portion 126 is sized to be narrower in width than a receiving portion 212 of the slot 210 and larger in width than the locking portion 216 of the slot 210 so that when in the locking position, the radially extending portion 126 interferes with the locking shelf 118 thereby preventing axial movement of the accessory 18 with respect to the base 14. The same is true for the locking lugs 214 of the accessory-side attachment mechanism 94 and the slots 110 of the tool-side attachment mechanism 90.

A locking actuator 138 enables rotation of the accessory-side attachment mechanism 94 relative to the tool-side attachment mechanism 90 to adjust the attachment mechanism 38 between the locked position and unlocked position. The locking actuator 138 extends from an outer circumferential edge of the accessory-side attachment mechanism 94 at a circumferential position corresponding to the relief cutout 66 of the main body 22 of the base 14, when the accessory 18 is installed on the base 14. The locking actuator 138 of the illustrated embodiment is integrally formed with the accessory-side attachment mechanism 94. The locking actuator 138 is extends beyond the housing 70 of the accessory and the main body 22 of the base 14 to allow an operator to rotate the accessory-side attachment mechanism 94, thus securing or releasing the accessory-side attachment mechanism 94 from the tool-side attachment mechanism 90. Specifically, as shown in FIG. 1, the locking actuator 138 extends through a relief cutout 66 in the main body 22. Rotation of the locking actuator 138 causes rotation of the accessory-side attachment mechanism 94 relative to the tool-side attachment mechanism 90 to secure or release the accessory 18 while the accessory housing 70 and main body 22 of the base 14 remain stationary. In some embodiments, the locking actuator 138 is biased to a rotational position corresponding to the locked position.

Referring to FIGS. 2 and 3, in some embodiments, the power tool 10 may further include features to help align and support the accessory 18 on the base 14. In the illustrated embodiment, the attachment mechanism 38 includes a plurality of guide pins 62 and alignment holes 86 that may be used to guide the accessory 18 onto the base 14. In the illustrated embodiment, the guide pins 62 extend axially from the front end 34 and the alignment holes 86 are positioned on the accessory 18. However, it should be understood that these features may be switched so that the guide pins 62 are on the accessory 18 and the alignment holes are on the base 14. The guide pins 62 and alignment holes 86 are configured to align the accessory 18 to guide the accessory 18 onto the base 14. The illustrated embodiment includes four guide pins 62 located at approximately four corners of the front end 34 when viewed along a rotational axis of the electric motor 46. Located centrally between the upper two guide pins 62 is the relief cutout 66 in the main body 22. The relief cutout 66 provides space for the actuator 138 of the attachment mechanism 38, as will be described in greater detail herein.

The housing 70 of the accessory 18 further includes the plurality of alignment holes 86 corresponding in number to the guide pins 62 of the base 14. The alignment holes 86 are located at approximately the four corners of the rear of the housing 70 when viewed along a longitudinal axis of the housing 70. Each alignment hole 86 is positioned to correspond to the opposing guide pin 62 on the base 14 such that the guide pin 62 can be received within the alignment hole 86. The components of the attachment mechanism 38 are oriented such that alignment of the alignment holes 86 and guide pins 62 properly aligns the accessory 18 and the base 14. Furthermore, the guide pins 62 and alignment holes 86 rotationally secure the accessory 18 to the base 14 when the accessory 18 is installed on the base 14.

To install an accessory 18 on the base 14, an operator first brings the accessory 18 to a position proximate the base 14 and aligns the attachment mechanism 38 components. The accessory 18 is oriented such that the locking actuator 138 is positioned proximate the relief cutout 66 and the alignment holes 86 are axially aligned with the corresponding guide pins 62. In the embodiment, where the locking actuator 138 is biased towards the locked position, the operator rotates the locking actuator 138 to move it towards the unlocked position. In the unlocked position the locking lugs 114 of the tool-side attachment mechanism 90 align with the receiving portion 212 of the slot 210 in the accessory-side attachment mechanism 94, and the locking lugs 214 of the accessory-side attachment mechanism 94 align with the receiving portion 112 portion of the slot 110 in the tool-side attachment mechanism 90. The operator then moves the accessory 18 axially towards the base 14 until the accessory 18 is properly seated on the front end 34 of the base 14. Specifically, the operator moves the accessory 18 towards the base 14 the locking lugs 114 of the tool-side attachment mechanism 90 pass through the corresponding slots 210 on the accessory-side attachment mechanism 94, and the locking lugs 214 on the accessory-side attachment mechanism 94 pass through the corresponding slots 110 on the tool-side attachment mechanism 90. The operator then releases the locking actuator 138 to allow the actuator 138 to return to the locked position. In the locked position the locking lugs 114 of the tool-side attachment mechanism 90 align with the locking portion 216 of the slot 210 in the accessory-side attachment mechanism 94, and the locking lugs 214 of the accessory-side attachment mechanism 94 align with the locking portion 116 portion of the slot 110 in the tool-side attachment mechanism 90. At this time, the accessory 18 is axially and rotationally secured to the base 14. The gear box 74 of the accessory 18 is mechanically coupled to the drive gear 54 to be driven by the electric motor 46. In the illustrated embodiment, the mechanical coupling is due to the drive gear 54 meshing with the planetary gear box 74 as the sun gear.

To remove an accessory 18 from the base 14, an operator rotates locking actuator 138 to the unlocked position such that locking lugs 114, 214 are misaligned with the locking shelves 118 then axially separates the accessory 18 from the base 14 until the accessory 18 is disengaged from the base 14.

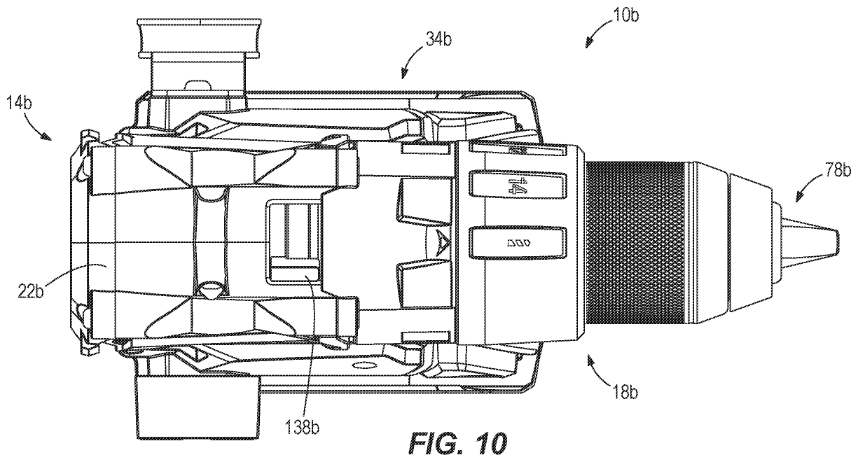

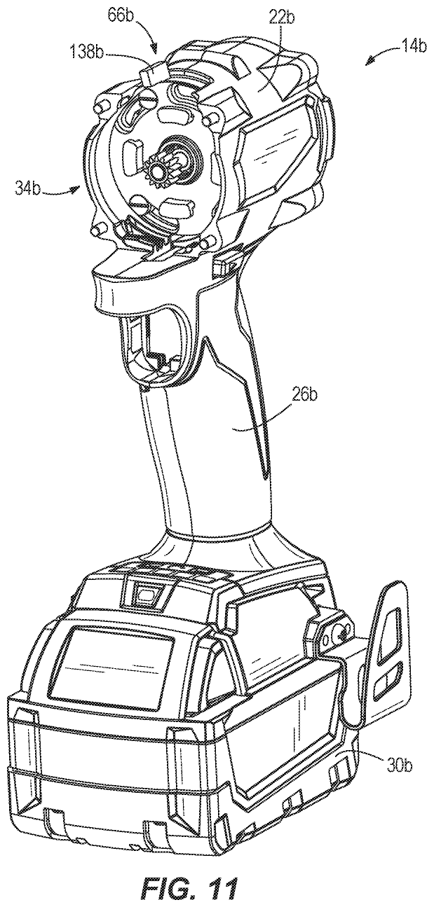

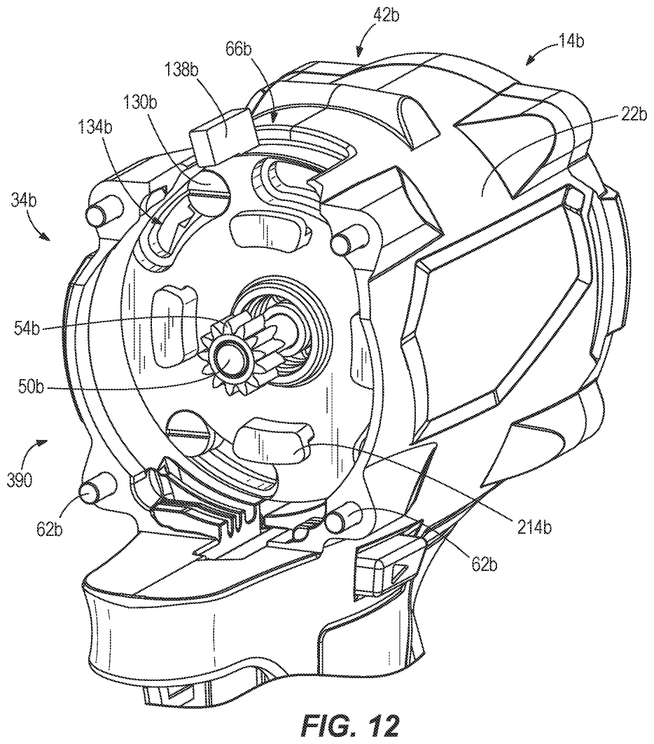

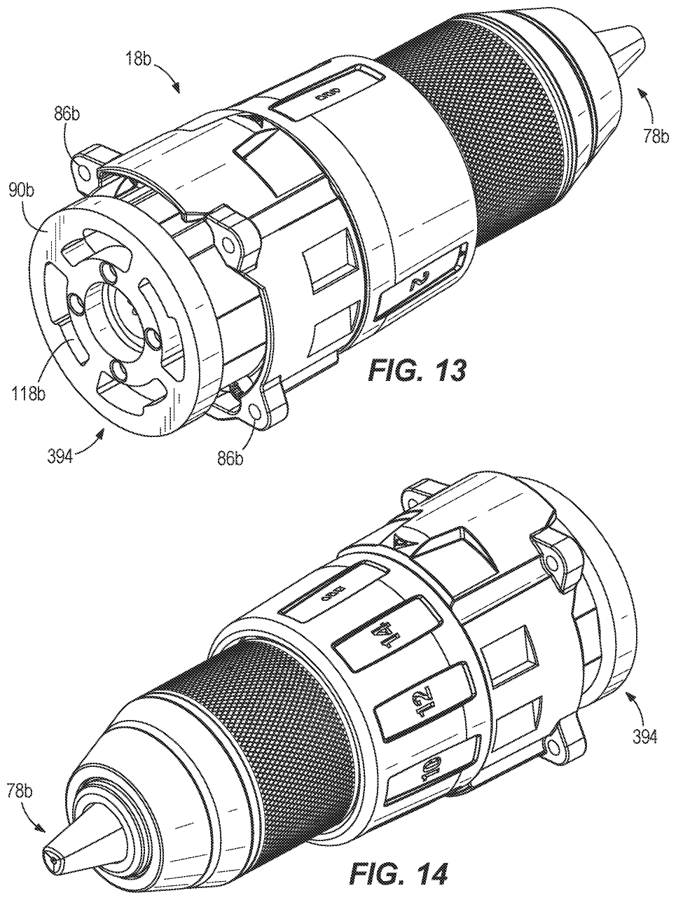

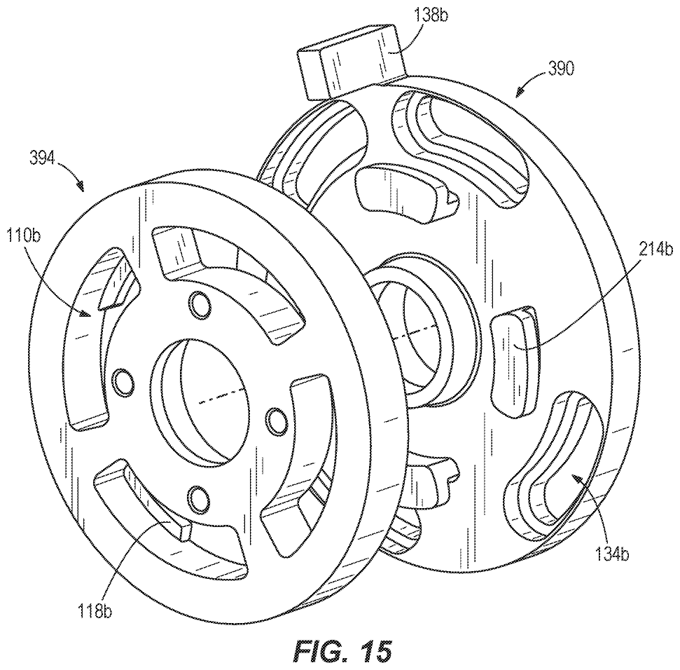

FIGS. 10-15 illustrate another embodiment of a rotary power tool 10b including a base 14b and an accessory 18b selectively coupled to the base, with like parts having like reference numerals plus the letter “b,” and the following differences explained below. In the embodiment of FIGS. 10-15, the tool-side attachment mechanism 390 is mounted in an axially fixed manner and is capable of limited rotation. The accessory-side attachment 394 is mounted in an axially and rotationally fixed manner. The features of the tool side attachment 390 correspond to the features of the accessory-side attachment 94 of the previously described embodiment, and the features of the accessory-side attachment 394 correspond to the features of the tool-side attachment 90 of the previously described embodiment. In other words, in the embodiment of FIGS. 10-15, the portions of the attachment mechanism 38b are located in the opposite positions as described in the embodiment above, while including the same features and operating in substantially the same way as the embodiment above to selectively coupled an accessory 18b to a rotary power tool 10b.

Although the disclosure has been described in detail with reference to certain embodiments, variations and modifications exist within the scope and spirit of one or more independent aspects of the disclosure as described.

Various features and advantages of the disclosure are set forth in the following claims.

What is claimed is:

1. A power tool system comprising:
a power tool base including
a main body,
an electric motor disposed within the main body, the electric motor including an output, and
a tool-side attachment mechanism coupled to the main body, the tool-side attachment mechanism having a tool-side locking lug and a tool-side slot adjacent the tool-side locking lug; and
an accessory configured to be selectively coupled to the power tool base and including
an accessory-side attachment mechanism having an accessory-side locking lug and an accessory-side slot, the accessory-side locking lug selectively engagable with the tool-side slot and the accessory-side slot selectively engagable with the tool-side locking lug,
a gear arrangement configured to be operably coupled to the output of the electric motor to receive torque from the electric motor, and
a tool holder configured to be driven by the gear arrangement,
wherein the accessory-side attachment mechanism selectively engages the tool-side attachment mechanism to couple the accessory to the power tool base.

2. The power tool system of claim 1, wherein the output of the power tool extends through and beyond the tool-side attachment mechanism.

3. The power tool system of claim 1, wherein the tool-side slot includes a receiving portion and a locking portion, the locking portion having a decreased width relative to the receiving portion.

4. The power tool system of claim 3, wherein the accessory-side locking lug includes an axially extending portion and a radially extending portion in the form of an L-shape.

5. The power tool system of claim 4, wherein the radially extending portion of the accessory-side locking lug is aligned with the locking portion when the accessory is coupled to the base, and wherein the locking portion impedes axial movement of the accessory in a direction away from the base.

6. The power tool system of claim 5, wherein the accessory-side attachment mechanism is rotatable toward an unlocked position in which the accessory-side locking lug is aligned with the receiving portion of the tool-side slot such that the locking portion does not impede axial movement of the accessory in a direction away from the base.

7. The power tool system of claim 1, wherein one of the power tool and the accessory includes an actuator, the actuator operable to rotate the accessory-side attachment and tool-side side attachment relative to one another between a locked and unlocked position.

8. The power tool system of claim 7, wherein the other of the power tool and the accessory includes a cutout through which the actuator extends, the cutout enabling limited movement of the actuator within the cutout.

9. The power tool system of claim 7, wherein the actuator is biased towards the locked position.

10. The power tool system of claim 1, wherein one of the main body and the accessory includes a plurality of pins, and wherein the other of the main body and the accessory includes a plurality of alignment holes configured to receive the pins when the accessory is coupled to the base.

11. The power tool system of claim 1, wherein the accessory is a first accessory, and further comprising a second accessory configured to be selectively coupled to the power tool base, the second accessory including
an accessory-side attachment mechanism selectively engagable with the tool-side attachment mechanism to axially couple the accessory to the power tool base,
a gear arrangement configured to be operably coupled to the output of the electric motor to receive torque from the electric motor, wherein the gear arrangement of the second accessory is different from the gear arrangement of the first accessory.

12. The power tool system of claim 11, wherein the first accessory and the second accessory are two different types of tools selected from the group consisting of: a drill, a reciprocating tool, a cutting tool, a rotary hammer, and a hammer drill.

13. An attachment mechanism for connecting an accessory to a rotary power tool, the attachment mechanism comprising:
a tool-side attachment including
a plurality of tool-side locking lugs extending from the tool-side attachment, and
a plurality of tool-side locking slots; and
an accessory-side attachment including
a plurality of accessory-side locking lugs extending from the accessory-side attachment, the plurality of accessory-side locking lugs engagable with the plurality of tool-side locking slots,
a plurality of accessory-side locking slots engagable with the plurality of tool-side locking lugs, and
an actuator extending from one of the accessory-side attachment or the tool-side attachment, the actuator operable to rotate the accessory-side attachment and tool-side side attachment relative to one another between a locked and an unlocked position.

14. The attachment mechanism of claim 13, wherein each of the tool-side locking slots includes a receiving portion and a locking portion, and wherein each of the accessory-side locking slots includes a receiving portion and a locking portion.

15. The attachment mechanism of claim 14, wherein each of the tool-side locking lugs includes an axially extending portion and a radially extending portion, and wherein each of the accessory-side locking lugs includes an axially extending portion and a radially extending portion.

16. The attachment mechanism of claim 15, wherein the radially extending portion of the tool-side locking lugs has a length less than a width of the receiving portion of the accessory-side locking slot and greater than a width of the locking portion of the accessory-side locking slot.

17. The attachment mechanism of claim 13, wherein the accessory-side attachment mechanism is rotatable relative to the accessory.

18. The attachment mechanism of claim 17, wherein rotation of the accessory-side attachment mechanism in a first direction axially couples the accessory-side attachment to the tool-side attachment mechanism, and wherein rotation of the accessory-side attachment mechanism in a second direction allows for axial movement between the tool-side attachment and the accessory-side attachment mechanism.

19. The attachment mechanism of claim 13, wherein the actuator is biased towards a locked position.

20. The attachment mechanism of claim 13, wherein the tool-side attachment includes a plate supporting the tool-side locking lugs and through which the tool-side slots are formed, and wherein the accessory-side attachment includes a plate supporting the accessory-side locking lugs and through which the accessory-side slots are formed.

21. An accessory for use with a rotary power tool having a tool-side attachment mechanism and an electric motor, the accessory comprising:
a housing having a front end and a rear end opposite the front end, the rear end configured to be selectively coupled to the rotary power tool;
an accessory-side attachment mechanism configured to selectively couple the accessory to the rotary power tool, the accessory-side attachment mechanism capable of limited rotation with respect to the housing;
a gear arrangement supported by the housing, the gear arrangement configured to receive torque from the electric motor when the accessory is coupled to the rotary power tool: and
a tool holder disposed within the housing closer to the front end than the gear arrangement and operably coupled to the gear arrangement.

22. The accessory of claim 21, wherein the accessory-side attachment mechanism includes a plate, a plurality of locking lugs extending from the plate, and a plurality of slots formed within the plate.

23. The accessory of claim 22, wherein the accessory-side attachment further incudes an actuator operable to rotate the plate between a locked and an unlocked position.

24. The accessory of claim 23, wherein the accessory-side attachment is biased towards the locked position.

25. The accessory of claim 21, wherein the accessory-side attachment mechanism includes a central aperture configured to receive an output of the rotary power tool electric motor therethrough such that the output may be coupled to the gear arrangement.

26. The accessory of claim 21, wherein the housing includes at least one of an alignment hole and a guide pin positioned on the rear end of the housing and configured to rotationally couple the accessory and the rotary power tool.

27. The accessory of claim 21, wherein the accessory-side attachment mechanism is rotatable between an unlocked position, in which the accessory is axially moveable relative to the rotary power tool, and a locked position, in which the accessory is axially coupled to the rotary power tool.

28. The accessory of claim 27, wherein the accessory is axially and rotationally fixed relative to the rotary power tool when the accessory-side attachment mechanism is in the locked position.

29. The accessory of claim 21, wherein the accessory is one of a drill, a reciprocating tool, a cutting tool, a rotary hammer, and a hammer drill.
